(19) United States
(12) Patent Application Publication
(10) Pub. No.: US 2025/0252347 A1
(43) Pub. Date: Aug. 7, 2025

(54) CLIENT SELECTION FOR ASYNCHRONOUS FEDERATED LEARNING

(71) Applicant: Cisco Technology, Inc., San Jose, CA (US)

(72) Inventors: Myungjin LEE, Bellevue, WA (US); Jaemin SHIN, Seattle, WA (US); Ramana Rao V. R. KOMPELLA, Foster City, CA (US)

(73) Assignee: Cisco Technology, Inc., San Jose, CA (US)

(21) Appl. No.: 18/435,668

(22) Filed: Feb. 7, 2024

(51) Int. Cl. G06N 20/00

(52) U.S. Cl. CPC G06N 20/00

(57) ABSTRACT

In one embodiment, an illustrative method herein may comprise: training a machine learning model using asynchronous federated learning with a plurality of trainer clients and respective data on the plurality of trainer clients; determining a measured utility of the respective data on each of the plurality of trainer clients; and selecting specific trainer clients from among the plurality of trainer clients that have a corresponding measured utility greater than a given utility threshold to use for training the machine learning model using asynchronous federated learning.

### TECHNICAL FIELD

The present disclosure relates generally to computer networks, and, more particularly, to client selection for asynchronous federated learning.

### BACKGROUND

Federated learning has garnered increased interest in recent years due to its ability to train more robust artificial intelligence (AI) models, as well as its capability to protect privacy. For instance, consider the case of a set of different hospitals across the world, each of which stores X-ray images from their own patients. Sharing such medical information to the cloud for model training, or even between one another, may be undesirable (or even illegal), in many circumstances. With federated learning, however, models can be trained at each of the sites and using their own local data. The resulting model parameters can then be aggregated to form a global model that has been trained using the X-ray images across all of the hospitals, but in a manner that does not require those images to actually be shared.

Predominantly, existing federated learning approaches perform synchronous aggregation of client updates. As clients spend large portion of their time idling while waiting for other clients with synchronous federated learning, asynchronous approaches have also been proposed, which allows clients to continue their training operations independent of the status of other participants.

While asynchronous approaches counteract the inefficiency of synchronous approaches by maximizing the utilization of each client's resources, asynchronous training also often results in slower training speeds and lower model accuracy. Moreover, stale model updates may result in noisy model updates when asynchronous training is used.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example federated learning architecture;

FIG. 4 illustrates an example procedure for an asynchronous federated learning algorithm with specific client selection;

FIG. 5 illustrates an example listing of federated learning clients and associated data utility measurements; and

FIG. 6 illustrates an example simplified procedure for client selection for asynchronous federated learning.

### DESCRIPTION OF EXAMPLE EMBODIMENTS

### Overview

According to one or more embodiments of the disclosure, an illustrative method herein may comprise: training, by a device, a machine learning model using asynchronous federated learning with a plurality of trainer clients and respective data on the plurality of trainer clients; determining, by the device, a measured utility of the respective data on each of the plurality of trainer clients; and selecting, by the device, specific trainer clients from among the plurality of trainer clients that have a corresponding measured utility greater than a given utility threshold to use for training the machine learning model using asynchronous federated learning.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

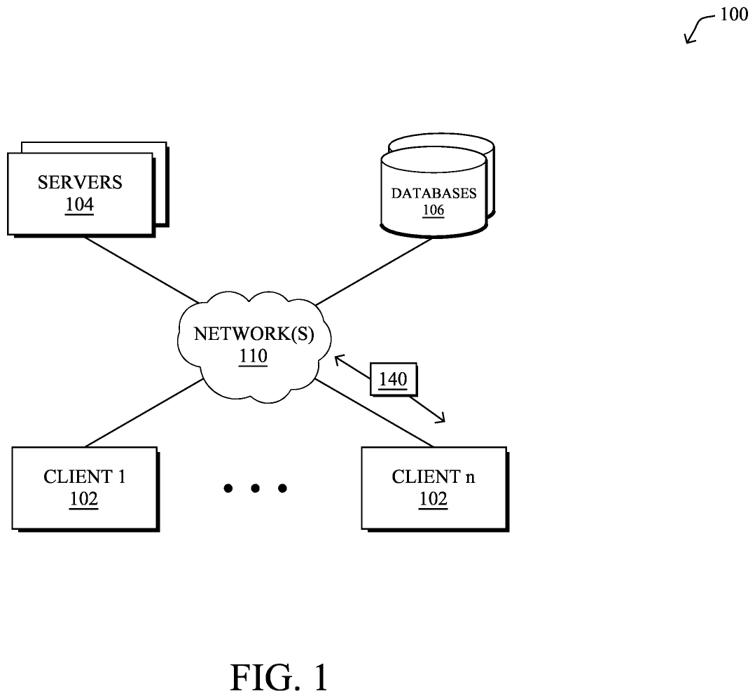

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

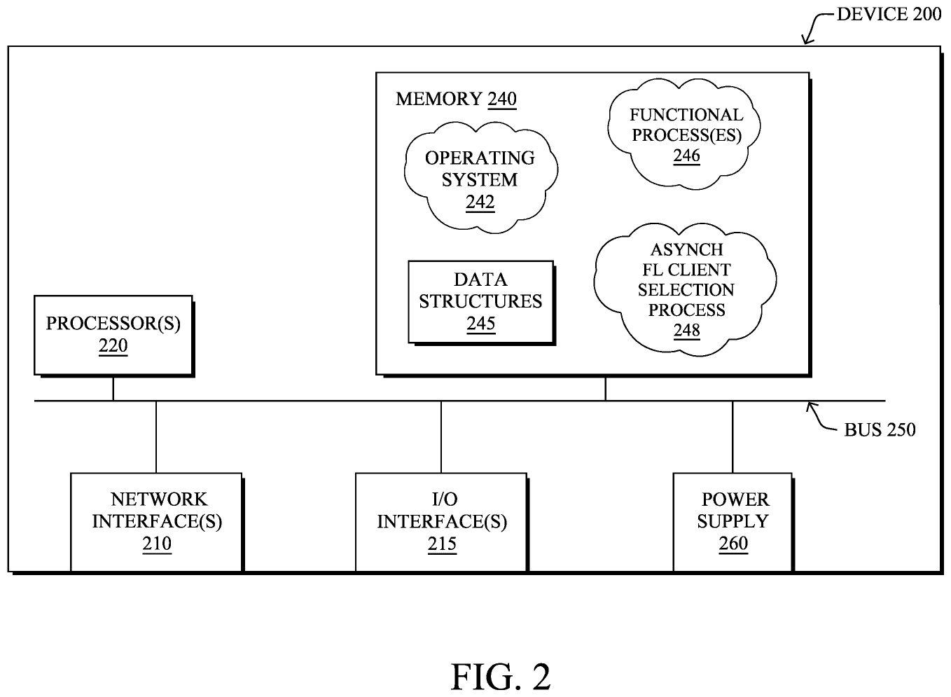

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an “async federated learning (FL) client selection” process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, async FL client selection process (process 248) may include computer executable instructions that, when executed by processor(s) 220, cause device 200 to perform the techniques described herein. To do so, in some implementations, process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

In further implementations, process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### ——Client Selection for Asynchronous Federated Learning——

As noted above, asynchronous federated learning approaches counteract the inefficiency of synchronous approaches by maximizing the utilization of each client's resources. However, as also noted above, asynchronous training also often results in slower training speeds and lower model accuracy, as asynchronous approaches tend to favor model training by faster clients, which exacerbates as the data distribution among clients are non-independent and identically distributed (IID). Moreover, stale model updates, particularly from the slow clients, may result in noisy model updates when asynchronous training is used.

The techniques herein, therefore, provide for client selection for asynchronous federated learning. In particular, the techniques as described in greater detail below improve the operation of asynchronous training in a federated learning system by blocking clients with low utility.

Specifically, according to one or more embodiments of the disclosure as described in detail below, an illustrative method herein may comprise: training a machine learning model using asynchronous federated learning with a plurality of trainer clients and respective data on the plurality of trainer clients; determining a measured utility of the respective data on each of the plurality of trainer clients; and selecting specific trainer clients from among the plurality of trainer clients that have a corresponding measured utility greater than a given utility threshold to use for training the machine learning model using asynchronous federated learning.

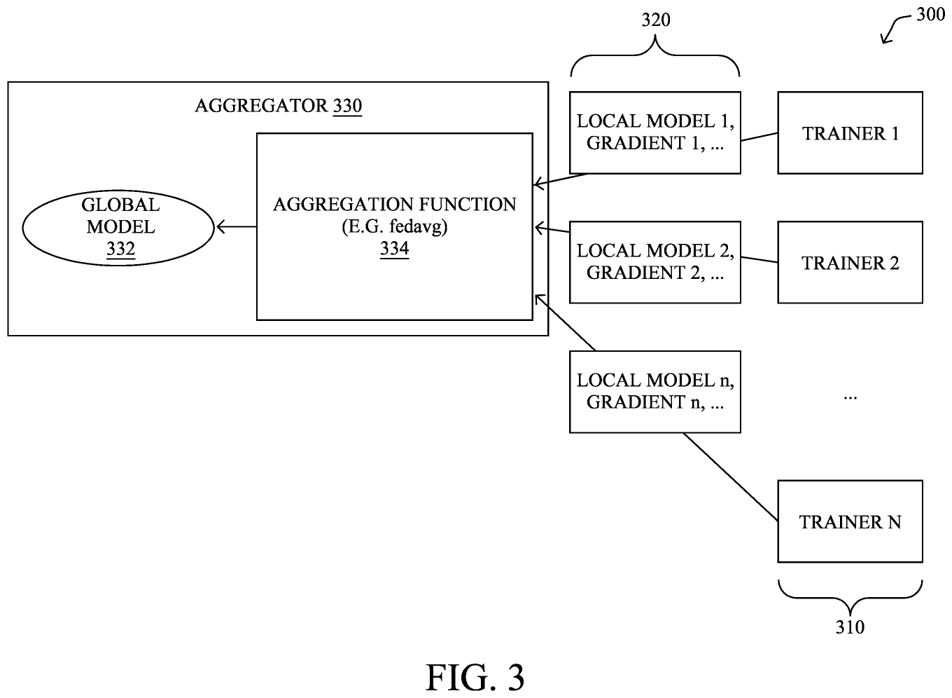

FIG. 3 illustrates an example federated learning architecture 300. In particular, a federated learning system typically involves N-number of trainer clients 310 (e.g., “trainer 1”, “trainer 2”, . . . “trainer N”) that each perform local training before sending the results 320 (e.g., “local model 1, gradient 1, . . . ” for trainers 1-N) to an aggregator 330, which aggregates the results into a global model 332 using an aggregation function 334 (e.g., FedBuff or otherwise, as described below).

More complex federated learning architectures may include intermediate aggregators that each aggregate the results of a subset of the trainer clients before sending their own results to the global aggregator. Other architectures may also have different trainer clients share results with one another, among others.

Regardless of the specific architecture selected, performing training in an asynchronous manner typically results in the system becoming biased towards updates from clients with faster training and communication speeds. For instance, the known “FedBuff” asynchronous federated learning approach operates by randomly selecting clients among available clients. In contrast, the techniques herein propose a specific methodology for selecting training clients to solve the problem of biased model updates of asynchronous federated learning, yet unsolved by FedBuff. Specifically, as shown herein, the selection blocks the clients with low local loss values (“utility” of the data) from being selected, as their data is already sufficiently trained by the model.

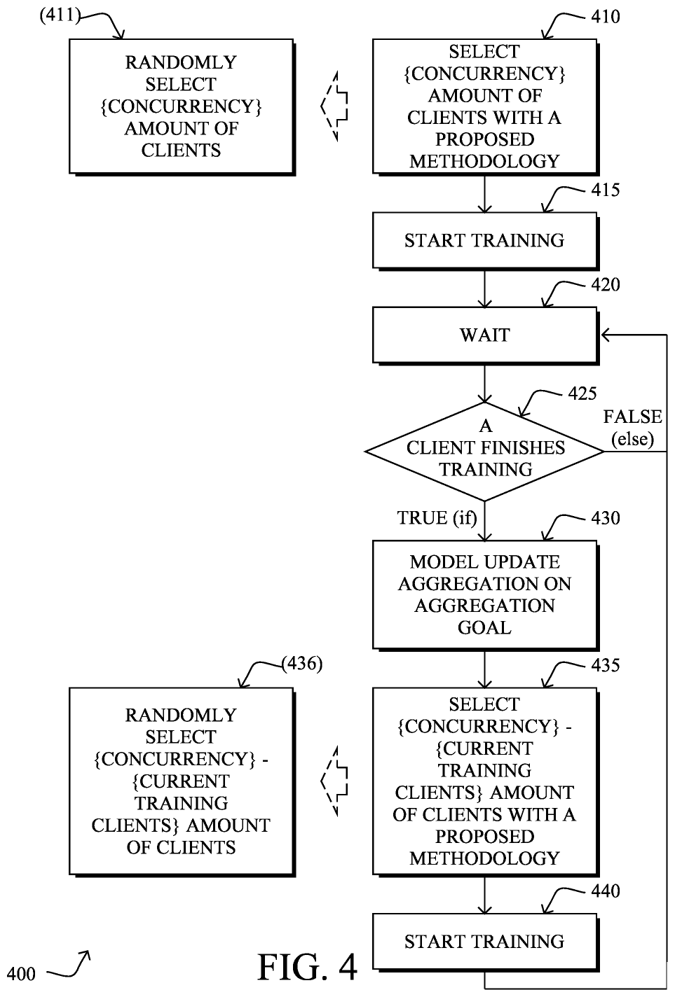

Operationally, FIG. 4 illustrates an example procedure (procedure 400) for an asynchronous federated learning algorithm with specific client selection according to one or more embodiments presented herein. In particular, the procedure 400 starts by selecting a {concurrency} amount of trainer clients using the proposed methodology herein. (Notably, this is in specific contrast to FedBuff, which randomly selects a {concurrency} amount of trainer clients, as shown in replaced FedBuff step 411.) In particular, the proposed methodology specifically aims to block the training of clients that have already sufficiently trained the model, illustratively based on selecting only those clients with high utility of the data (loss) as described herein.

The procedure 400 may then start training in step 415, and waits in step 420 until one or more trainer clients finish training in step 425 (e.g., TRUE (if), otherwise, FALSE (else) and returning to step 420 to wait). At this time, in step 430, the procedure 400 performs model update aggregation on the aggregation goal, accordingly.

Now, in step 435, the procedure 400 according to the techniques herein further selects a {concurrency}—{current training clients} amount of trainer clients using the proposed methodology herein. This step specifically exchanges trainer clients that have finished a training with a new trainer client selected from a limited grouping of available clients, namely those with high utility that have yet to sufficiently train the model (i.e., blocking those with low utility that have already sufficiently trained the model). (Notably, step 435 is in specific contrast to FedBuff, which randomly selects a {concurrency}—{current training clients} amount of trainer clients, as shown in replaced FedBuff step 436.)

The procedure 400 may then continue to start training on those newly selected trainer clients in step 440, returning to step 420 to await further training to finish, accordingly.

As shown above, the proposed approach thus selects specific clients, rather than using random selection. More specifically, the client selection methodology aims to mitigate the problem of asynchronous training being biased towards clients with faster computation and communication speed. To this end, the techniques herein block the training of clients that have already sufficiently trained the model.

In various implementations, the system measures the utility of the data (loss) on clients and blocks the training by clients with a utility lower than a utility bar threshold value. The utility (loss) value of the client data shows how much the model have already trained and been biased towards the data, which becomes an effective metric for the client selection herein to block biased clients. That is, loss, as is currently understood in the art, is a number indicating how “bad” a model's prediction was on a single example. If the model's prediction is perfect, the loss is zero; otherwise, the loss is greater. The goal of training a model is to find a set of weights and biases that have low loss, on average, across all examples. As such, those trainer clients with a higher loss are particularly useful to continue training in order to converge on the model with sufficient representation from all clients, accordingly. (Note that loss is one example measurement of data utility herein, and that other measurements that would be indicative of a trainer client's utility may be used in accordance with the techniques herein.)

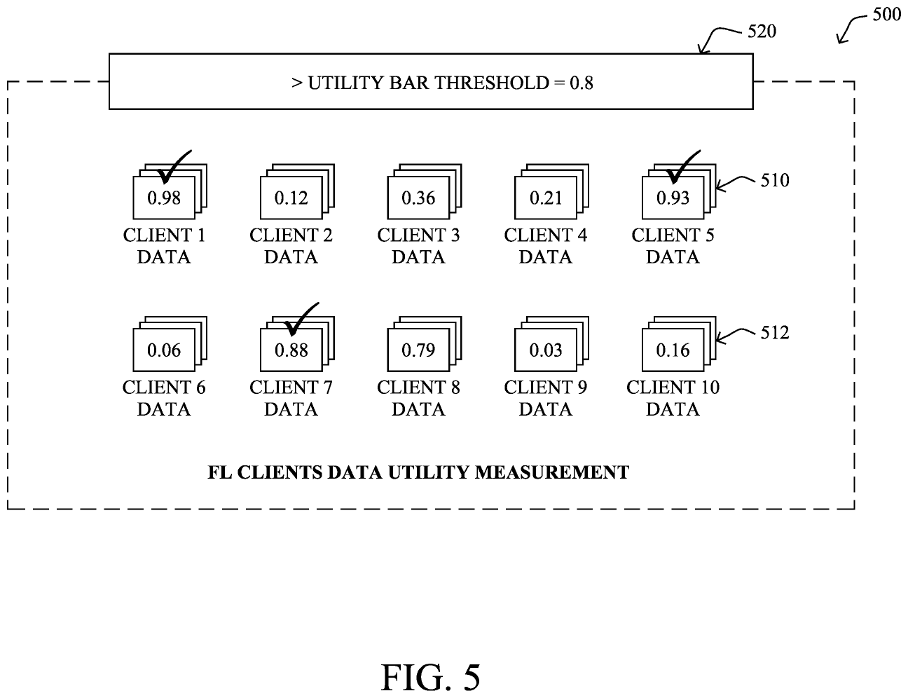

FIG. 5 illustrates an example listing of federated learning clients and associated data utility measurements. In particular, the listing 500 shows a plurality of clients data (e.g., clients 1-10), where a representation of a utility measurement is shown for each client (e.g., “0.98” for client 1 data). The scale of utility (loss) measurement may be based on any appropriate calculation, such as from 0.0-1.0 (e.g., a percentage) as is the current calculation of loss.

As illustrated in FIG. 5, certain clients (e.g., clients 1, 5, and 7) are shown with an illustrative checkmark, indicating that they are selectable training clients 510 according to the selection algorithm herein. Other clients (e.g., clients 2-4, 6, and 8-10) are shown without the illustrative checkmark, indicating that they are blocked training clients 512 according to the selection algorithm herein. As described herein, the decision on being within a pool of selectable clients or blocked clients may be based on selecting those with high utility (loss) that have yet to sufficiently train the model, and blocking those with low utility (loss) that have already sufficiently trained the model. As shown, a utility bar threshold 520 is shown (e.g., “0.8”, though any value may be selected, set, determined, and so forth).

Notably, the utility bar threshold 520 may be configured statistically or dynamically, in various instances. In addition, an administrator could choose a fixed threshold value based on the prior knowledge, or the threshold could be controlled dynamically during training. One example is to use a mean utility value of current clients' utility values—as clients train a model, the utility (loss) values decreases in general, but the mean-based thresholding will be kept updated and will continue to block clients that are relatively more trained than others. This could be potentially more robust compared to fixed thresholding, which could block all the clients as the training proceeds and the utility (loss) decreases. The dynamic threshold could also be chosen by statistics other than mean of the clients' utility set, such as median, quartiles, percentiles, or actively changing in between different thresholding methodologies during training.

In one implementation, among the clients with utility greater than the threshold utility, the system herein may be configured to select clients with higher utility data, to maximize the contribution of clients at every asynchronous training event. For example, from the illustration of listing 500, client 1 may be selected prior to client 5, and then client 7, accordingly.

Also, in one implementation herein, as measuring the utility (loss) at every ‘select_clients’ function call may result in large latency overhead from model inference, the system herein may acquire loss naturally from the client training process, and maintains the listing 500 above, accordingly.

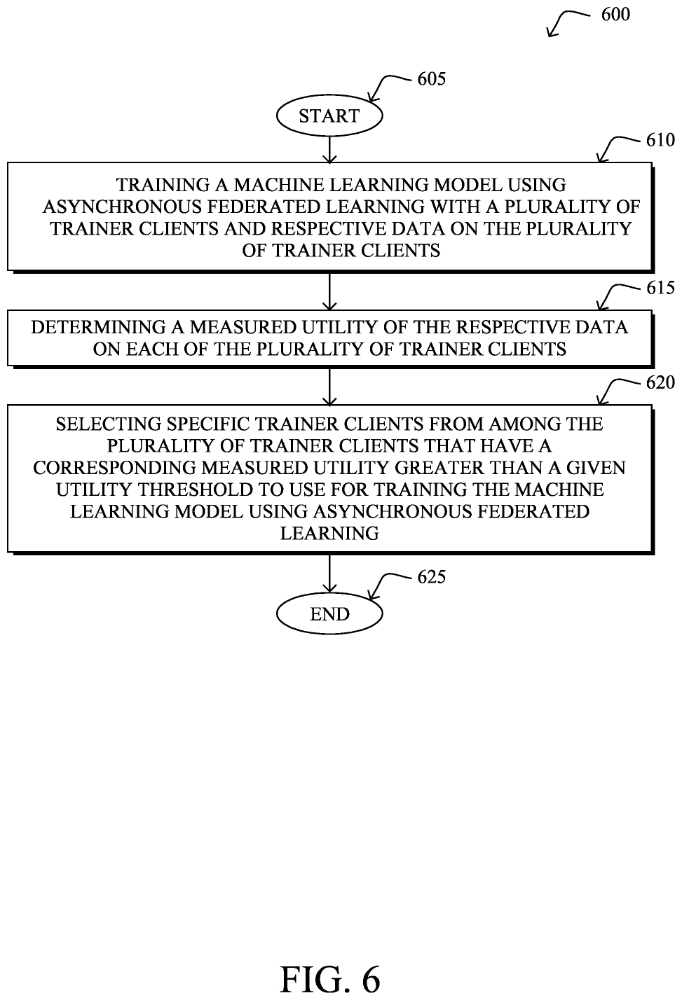

In closing, FIG. 6 illustrates an example simplified procedure for client selection for asynchronous federated learning in accordance with one or more embodiments described herein. For example, a non-generic, specifically configured device (e.g., device 200, an apparatus) may perform procedure 600 by executing stored instructions (e.g., process 248). The procedure 600 may start at step 605, and continues to step 610, where, as described in greater detail above, the techniques herein train a machine learning model using asynchronous federated learning with a plurality of trainer clients and respective data on the plurality of trainer clients.

In step 615, the techniques herein determine a measured utility of the respective data on each of the plurality of trainer clients. For instance, as described above, the measured utility of the respective data on each of the plurality of trainer clients may comprise a training-based loss metric. In addition, in one implementation, the techniques herein may measure the measured utility of the respective data on each of the plurality of trainer clients by acquiring a loss metric from a training process by each of the plurality of trainer clients.

In step 620, the techniques herein may correspondingly select specific trainer clients from among the plurality of trainer clients that have a corresponding measured utility greater than a given utility threshold to use for training the machine learning model using asynchronous federated learning. That is, as described in greater detail above, selecting the specific trainer clients specifically blocks certain trainer clients from among the plurality of trainer clients with corresponding measured utilities less than the given utility threshold from being used for training the machine learning model using asynchronous federated learning. Note that selecting the specific trainer clients may be in response to previous trainer clients finishing training to replace the previous trainer clients to meet a concurrency of the asynchronous federated learning. Also, in one implementation as mentioned above, selecting includes prioritizing, from within the specific trainer clients, a particular trainer client with a highest corresponding measured utility as compared to other trainer clients of the specific trainer clients.

In accordance with one or more specific implementations herein, the given utility threshold may be static, or else the techniques herein may adjust the given utility threshold dynamically. For instance, the techniques herein may calculate a statistical utility value of the plurality of trainer clients based on measured utilities of the respective data on current trainer clients currently selected for training the machine learning model, and may adjust the given utility threshold dynamically based on the statistical utility value. As examples, computing the statistical utility value may be based on one or more of: a mean, a median, a quartile, or a percentile, as noted above. Note, too, that the techniques herein may change methodologies for adjusting the given utility threshold during continued training of the machine learning model using asynchronous federated learning. Also, in one implementation, the techniques herein may also start with a static utility threshold as the given utility threshold, and may adjust the given utility threshold dynamically based on continued training of the machine learning model using asynchronous federated learning.

Procedure 600 may end at step 625.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process, when executed, configured to: train a machine learning model using asynchronous federated learning with a plurality of trainer clients and respective data on the plurality of trainer clients; determine a measured utility of the respective data on each of the plurality of trainer clients; and select specific trainer clients from among the plurality of trainer clients that have a corresponding measured utility greater than a given utility threshold to use for training the machine learning model using asynchronous federated learning.

In still other implementations, a tangible, non-transitory, computer-readable medium storing program instructions that cause a device to execute a process comprising: training a machine learning model using asynchronous federated learning with a plurality of trainer clients and respective data on the plurality of trainer clients; determining a measured utility of the respective data on each of the plurality of trainer clients; and selecting specific trainer clients from among the plurality of trainer clients that have a corresponding measured utility greater than a given utility threshold to use for training the machine learning model using asynchronous federated learning.

The techniques described herein, therefore, provide for client selection for asynchronous federated learning. Notably, various approaches have been proposed for client selection during model training. Many of which are specifically focused on client selection strategy for synchronous FL. For instance, certain known techniques may prioritize clients with low failure rate while optimizing selection fairness via reinforcement learning. Others may prioritize clients with high local loss and faster training and communication speed, while still others prioritize clients with high local loss. Further alternative techniques propose client selection strategies that prioritize clients with higher contribution (i.e., improvements in model accuracy due to a client). All of these approaches, however, are built on synchronous federated learning. The techniques herein, on the other hand, targets asynchronous federated learning, and specifically solves its problem of biased model updates, such as by “blocking” the clients with low local loss values (utility) from being selected (e.g., regardless of the client speed).

Illustratively, the techniques described herein may be performed by hardware, software, and/or firmware, (e.g., an “apparatus”) such as in accordance with the async FL client selection process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
training, by a device, a machine learning model using asynchronous federated learning with a plurality of trainer clients and respective data on the plurality of trainer clients;
determining, by the device, a measured utility of the respective data on each of the plurality of trainer clients; and
selecting, by the device, specific trainer clients from among the plurality of trainer clients that have a corresponding measured utility greater than a given utility threshold to use for training the machine learning model using asynchronous federated learning.

2. The method of claim 1, wherein selecting the specific trainer clients specifically blocks certain trainer clients from among the plurality of trainer clients with corresponding measured utilities less than the given utility threshold from being used for training the machine learning model using asynchronous federated learning.

3. The method of claim 1, wherein selecting the specific trainer clients is in response to previous trainer clients finishing training to replace the previous trainer clients to meet a concurrency of the asynchronous federated learning.

4. The method of claim 1, wherein selecting comprises:
prioritizing, from within the specific trainer clients, a particular trainer client with a highest corresponding measured utility as compared to other trainer clients of the specific trainer clients.

5. The method of claim 1, further comprising:
measuring the measured utility of the respective data on each of the plurality of trainer clients by acquiring a loss metric from a training process by each of the plurality of trainer clients.

6. The method of claim 1, wherein the measured utility of the respective data on each of the plurality of trainer clients comprises a training-based loss metric.

7. The method of claim 1, wherein the given utility threshold is static.

8. The method of claim 1, further comprising:
adjusting the given utility threshold dynamically.

9. The method of claim 8, further comprising:
calculating a statistical utility value of the plurality of trainer clients based on measured utilities of the respective data on current trainer clients currently selected for training the machine learning model; and
adjusting the given utility threshold dynamically based on the statistical utility value.

10. The method of claim 9, further comprising:
computing the statistical utility value based on one or more of: a mean, a median, a quartile, or a percentile.

11. The method of claim 8, further comprising:
changing methodologies for adjusting the given utility threshold during continued training of the machine learning model using asynchronous federated learning.

12. The method of claim 1, further comprising:
starting with a static utility threshold as the given utility threshold; and
adjusting the given utility threshold dynamically based on continued training of the machine learning model using asynchronous federated learning.

13. An apparatus, comprising:
one or more network interfaces to communicate with a network;
a processor coupled to the one or more network interfaces and configured to execute one or more processes; and
a memory configured to store a process that is executable by the processor, the process, when executed, configured to:
train a machine learning model using asynchronous federated learning with a plurality of trainer clients and respective data on the plurality of trainer clients;
determine a measured utility of the respective data on each of the plurality of trainer clients; and
select specific trainer clients from among the plurality of trainer clients that have a corresponding measured utility greater than a given utility threshold to use for training the machine learning model using asynchronous federated learning.

14. The apparatus of claim 13, wherein selection of the specific trainer clients specifically blocks certain trainer clients from among the plurality of trainer clients with corresponding measured utilities less than the given utility threshold from being used for training the machine learning model using asynchronous federated learning.

15. The apparatus of claim 13, wherein selection of the specific trainer clients is in response to previous trainer clients finishing training to replace the previous trainer clients to meet a concurrency of the asynchronous federated learning.

16. The apparatus of claim 13, wherein the process, when executed to select, is configured to:
prioritize, from within the specific trainer clients, a particular trainer client with a highest corresponding measured utility as compared to other trainer clients of the specific trainer clients.

17. The apparatus of claim 13, wherein the process, when executed, is further configured to:
measure the measured utility of the respective data on each of the plurality of trainer clients by acquiring a loss metric from a training process by each of the plurality of trainer clients.

18. The apparatus of claim 13, wherein the process, when executed, is further configured to:
adjust the given utility threshold dynamically.

19. The apparatus of claim 18, wherein the process, when executed, is further configured to:
calculate a statistical utility value of the plurality of trainer clients based on measured utilities of the respective data on current trainer clients currently selected for training the machine learning model; and
adjust the given utility threshold dynamically based on the statistical utility value.

20. A tangible, non-transitory, computer-readable medium storing program instructions that cause a device to execute a process comprising:
training a machine learning model using asynchronous federated learning with a plurality of trainer clients and respective data on the plurality of trainer clients;
determining a measured utility of the respective data on each of the plurality of trainer clients; and
selecting specific trainer clients from among the plurality of trainer clients that have a corresponding measured utility greater than a given utility threshold to use for training the machine learning model using asynchronous federated learning.
